(19) United States
(12) Patent Application Publication
(10) Pub. No.: US 2009/0086777 A1
(43) Pub. Date: Apr. 2, 2009

(54) OPTICAL DISK DRIVE AND LASER POWER CONTROL METHOD

(75) Inventor: Hiroshi Nakane, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/238,005

(22) Filed: Sep. 25, 2008

(30) Foreign Application Priority Data
Sep. 28, 2007 (JP) 2007-256518

(51) Int. Cl. H01S 3/13

(52) U.S. Cl. 372/29.021; 372/29.02

(57) ABSTRACT

According to one embodiment, an optical disk drive includes a monitor diode which monitors a laser output of a laser diode irradiating a laser beam to an optical disk, a detector which sets an output termination mode when a state that a monitor signal obtained from the monitor diode exceeds a first reference value continues over a predetermined period is detected from a deglitch, a switch section which terminates the laser output of the laser diode upon setting of the output termination mode, and a controller which supplying a drive signal for reducing a difference obtained as a comparison result between the monitor signal and a second reference value smaller than the first reference value. The controller serves as a software-based digital filter which realizes an equalizer function of making phase compensation of the comparison result.

### CROSS-REFERENCE TO RELATED APPLICATIONS

This application is based upon and claims the benefit of priority from Japanese Patent Application No. 2007-256518, filed Sep. 28, 2007, the entire contents of which are incorporated herein by reference.

### BACKGROUND

1. Field

One embodiment of the present invention relates to an optical disk drive and a laser power control method, which digitally controls a laser power in a software basis.

2. Description of the Related Art

Recently, in optical disk drives, kinds of digital processing are rapidly expanding along with the swift advances in the integration of digital ICs. Such digital processing is advantageous in that it can be implemented with the use of hardware integrated as a digital IC to reduce the cost. The digital processing has been already applied to focus and tracking servos of a pickup. However, the digital processing has not been applied to feedback loop for an automatic laser power control (APC), yet. The main reason resides in that a software-based controller which operates by executing software is used as a digital filter for realizing an equalizer characteristic required for a servo. For this reason, there is a possibility of the out-of-control of the foregoing controller. The out-of-control of the controller is detectable by a watchdog timer, for example. However, a laser diode used as a laser beam source is instantaneously destroyed if the out-of-control of the controller occurs, unlike actuators for the focus and tracking servos. For this reason, the out-of-control of the controller is detected, but the laser diode is not protected.

Conventionally, a technique of protecting a laser diode from an eddy current flowing in error has been proposed (e.g., see Jpn. Pat. Appln. KOKAI Publication No. Hei 5-94633). According to the technique, a laser diode protection circuit is provided with a laser diode, a read constant current circuit and a write constant current circuit. The protection circuit supplies a read constant current to the laser diode from the read constant current circuit in accordance with a read input signal in a read operation. In a write operation, the protection circuit adds a write constant current from the write constant current circuit to the read constant current in accordance with a write input signal, and supplies a resultant current to the laser diode. A switch element and a limiting resistor are connected in parallel between the read constant current circuit and the laser diode. When light emission of the laser diode in the read operation is more than a predetermined emission or when a current or voltage value of the read input signal I is more than a predetermined value, the switch element supplies the read constant current to the laser diode via the limiting resistor; which therefore turns the laser diode off. The foregoing control is carried out in order to securely prevent the laser diode from being destroyed in the manufacture process before delivery on the market.

However, according to the technique disclosed in the foregoing Publication Hei 5-94633, the greatest priority is given to the protection of the laser diode. For this reason, even if noise is temporarily mixed in a monitor output of the laser diode, the protection circuit functions to terminate a laser output of the laser diode. Thus, the laser output is terminated whenever noise temporarily occurs. According to the foregoing laser power control, it is difficult to continue recording/reading with respect to an optical disk.

If the out-of-control (runaway) of the foregoing software-based controller occurs, the controller is not used to terminate the laser output. For this reason, the laser output must be terminated using an independent hardware protection circuit. In addition, when the laser output is actually terminated, the power of the controller must be again made to return the laser output from the termination state. Further, the controller must be reset according a signal from an external host device. As a result, much time is wastefully spent.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the configuration of an optical disk drive according to one embodiment of the present invention;

FIG. 2 is an exemplary view showing the configuration of an APC circuit 24 shown in FIG. 1;

FIG. 3 is an exemplary view showing the flow of laser power control executed by the circuit having the configuration shown in FIG. 2;

FIG. 4 is an exemplary view showing a waveform of a signal obtained in the laser power control shown in FIG. 3;

FIG. 5 is an exemplary view showing time transition of noise by electrostatic discharge; and

FIG. 6 is an exemplary view showing the configuration of a circuit 24 executing laser power control in a recording operation.

### DETAILED DESCRIPTION

Various embodiments according to the present invention will be hereinafter described with reference to accompanying drawings.

According to one embodiment of the present invention, there is provided an optical disk drive which comprises: a monitor which monitors a laser output of a laser beam source irradiating a laser beam to an optical disk; a detector which sets an output termination mode when a state that a monitor signal obtained from the monitor exceeds a first reference value continues over a predetermined period is detected from a deglitch; an output termination circuit which terminates the laser output of the laser beam source upon setting of the output termination mode; and a controller which supplies a drive signal for reducing a difference obtained as a comparison result between the monitor signal and a second reference value smaller than the first reference value to the laser beam source; the controller serving as a software-based digital filter which realizes an equalizer function of making phase compensation of the comparison result.

According to one embodiment of the present invention, there is provided a laser power control method which comprises: setting an output termination mode when a state that a monitor signal obtained by monitoring a laser output of a laser beam source irradiating a laser beam to an optical disk exceeds a first reference value continues over a predetermined period is detected; terminating the laser output of the laser beam source upon setting of the output termination mode; supplying a drive signal for reducing a difference obtained as a comparison result between the monitor signal and a second reference value smaller than the first reference value to the laser beam source; and realizing an equalizer function of making phase compensation of the comparison result by a controller which serves as a software-based digital filter.

In the optical disk drive and according to the laser power control method, the output termination mode is set when a state that a monitor signal obtained from the monitor exceeds a first reference value continues over a predetermined period is detected from a deglitch. The laser output of the laser beam source is terminated upon setting of the output termination mode. For example, even if the monitor signal temporarily increases due to electrostatic noise entered therein and exceeds the first reference value, the output termination mode is not set in a case where such an increase is disappeared within the foregoing predetermined period. Thus, it is possible to prevent the laser output of the laser beam source from being unnecessarily terminated. If the out-of-control of the software controller occurs, an increase of the monitor signal is not cancelled within the predetermined period; therefore, the laser beam source is securely protected from being destroyed.

Hereinafter, the optical disk drive according to one embodiment of the present invention will be described.

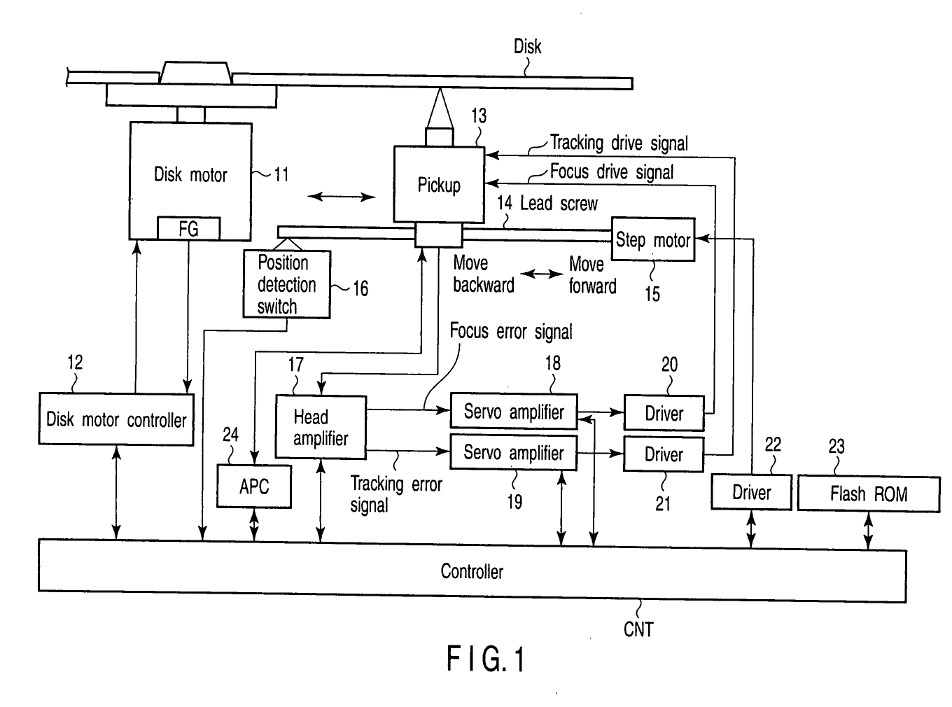

FIG. 1 shows the configuration of the optical disk drive. A disk is loaded on a disk motor 11 to be freely rotatable. The disk motor 11 is provided with a frequency generator FG. Usually, the frequency generator FG generates a signal in accordance with a rotational angle using an output of a hall element. The hall element detects an electromotive force (voltage) of a field coil of a rotor or a rotational angle of a magnet of the rotor. In this case, the frequency generator FG outputs about 18 pulses per rotation as a rotational angle signal of the disk motor 11. Then, these pulses are supplied to a controller CNT via a disk motor controller 12. The controller CNT compares the rotational angle signal from the frequency generator FG with an internal reference frequency. According to the comparison result error signal, the controller CNT controls the disk motor controller 12 so that the disk motor is set to a predetermined rotating direction and rotational speed.

A pickup 13 is set to face an information recording surface of the disk. The pickup 13 is supported by a movable shaft (not shown) so that it freely movable in a radius direction of the disk. In this case, the pickup 13 is moved using a lead screw 14. A step motor 15 functions as a feed motor of the pickup 13, and has a rotating shaft directly connected with the lead screw 14. A position detection switch 16 is provided at a home position of the pickup 13. The position detection switch 16 detects that the pickup 13 arrives at the home position when the pickup 13 moves to an inner circumferential side of the disk, and then contacts the position detection switch 16. The position detection switch 16 is used for initializing the position of the pickup 13. The home position of the pickup 13 is set to a disk radius=25 mm, for example. The controller CNT controls a driver 22 when the switch 16 detects the pickup 13 to move step motor 15. In this case, the step motor 15 moves the pickup 13 at a ratio of 3 mm per rotation.

The pickup 13 is provided with a laser beam source, which comprises three laser diodes LD (semiconductor lasers) and a single monitor diode MD. The wavelength of the semiconductor lasers is set to 780 nm, 650 nm and 405 nm corresponding to CD, DVD and HD-DVD. The foregoing three semiconductor lasers are not simultaneously emitted; therefore, the monitor diode MD is used in common by three laser diodes. In addition, an automatic power control (APC) circuit 24 is used in common by three laser diodes LD. The automatic power control (APC) circuit 24 controls a current flowing through the laser diode LD so that each output of the laser diodes becomes constant. The APC circuit 24 is controlled according software by the controller CNT in order to change the output of each laser diode and to turn off each laser diode.

The laser beam is divided into three beams by a diffraction grating, and then, collected onto an objective lens via optical components of the pickup 13, and thus, irradiated to form a spot on an information recording surface of the disk. The diffraction grating is provided for each of CD, DVD and HD-DVD laser diode LD. On the information recording surface, a DVD spot size I is about 0.94 μm, and an HD-DVD spot size is about 0.55 μm. In this embodiment, the main beam only will be described, and the details of Differential push-pull (DPP) using three beams mainly in the recording operation are omitted.

The laser beam reflected on the disk returns to the objective lens, and then, is incident on an 8-divided detector via an internal optical component (not shown). A focus error signal employs astigmatism, and a tracking error signal employs DPP. The detector makes current-to-voltage conversion of the incident light using an IC built in the pickup, and thereafter, outputs the conversion result signal to a predetermined head amplifier 17.

The objective lens is supported by a spring so that it is freely movable in an optical axis direction (focus direction) of the laser beam and a radius direction (track direction) of the disk. According to this embodiment, a coil and a magnet are provided to drive the objective lens in the focus direction and the track direction. The coil functions as a movable member, and the magnet functions as a stationary member. The two-direction operating member is called a biaxial actuator. A focus coil is driven by a focus drive signal output from a driver 20. A tracking coil is driven by a tracking drive signal output from a driver 21. The drivers 20 and 21 are connected to servo amplifiers 18 and 19, respectively. The servo amplifier 18 generates a focus drive signal corresponding to the focus error signal from the head amplifier 17 by the control of the controller CNT. The servo amplifier 19 generates a tracking drive signal corresponding to the tracking error signal from the head amplifier 17 by the control of the controller CNT.

The controller CNT acquires disk address information from a high frequency (RF) signal obtained as an information signal from the head amplifier and other signals using CD, DVD, HD-DVD demodulators and an address decoder, which are not shown. The controller CNT generates two-phase sine wave signals to control the step motor 15, and then, amplifies the signal power to output it to the step motor 15.

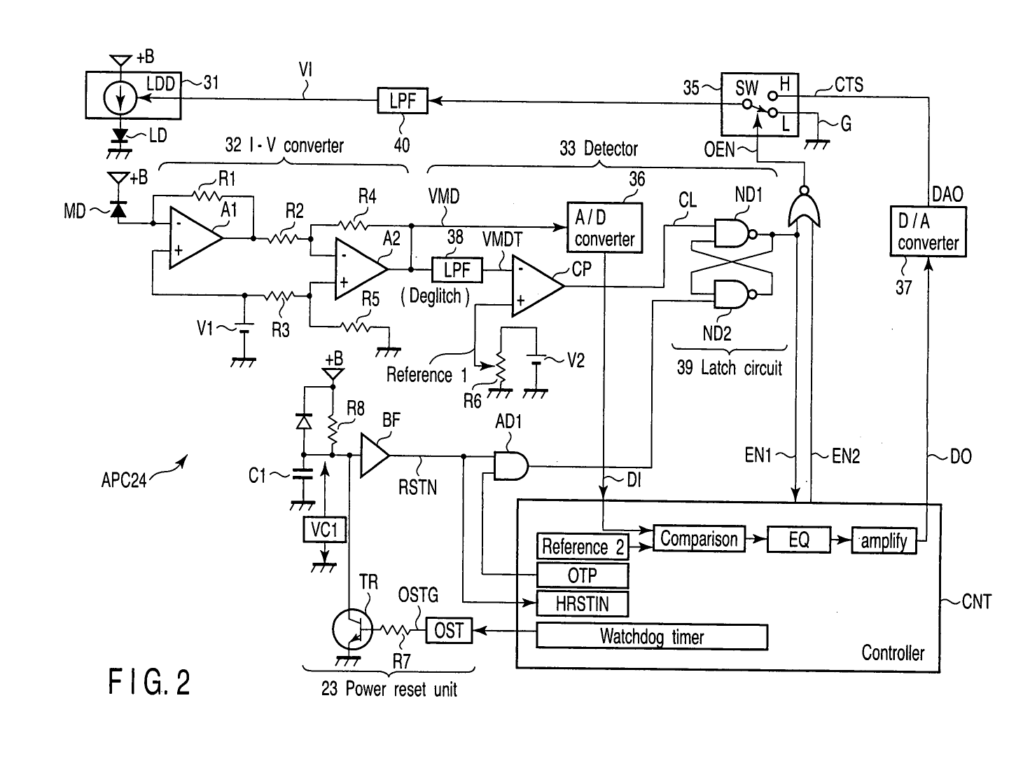

FIG. 2 shows the configuration of the APC circuit 24 shown in FIG. 1 in more detail. The APC circuit 24 includes an I-V converter 32, a detector 33, a power reset unit 34, a switch unit 35, an A/D converter 36 and a D/A converter 37. The controller CNT operates in cooperation with the APC circuit 24. The I-V converter 32 makes a current-to voltage conversion of a monitor signal from the monitor diode MD. The I-V converter 32 is composed of differential amplifiers A1, A2, resistors R1 to R5 and a reference power source V1. The controller CNT supplies a drive signal for reducing the difference obtained as a comparison result between the monitor signal and a second reference value smaller than a first reference value, to a laser driver 31. The controller carries a current corresponding to the foregoing drive signal to a laser diode LD.

The detector 33 sets an output termination mode when a state that the monitor signal exceeds the first reference value continues for a predetermined time is detected from a deglitch. The detector 33 is composed of a deglitch low-pass filter 38, a latch circuit 39, a comparator CP and a reference power source V2. The latch circuit 39 latches the deglitch result of the low-pass filter 38 to set the output termination mode. The latch circuit 39 is configured as an RS flip-flop combining NAND circuits ND1 and ND2. The switch unit 35 and a delay low-pass filter 40 form an output termination circuit for terminating a laser output of the laser beam source upon setting of the output termination mode. In this case, the delay low-pass filter 40 is provided for delaying the drive signal supplied to the laser driver 31 for a time longer than a deglitch reference predetermined time.

The controller CNT serves as a software-based digital filter which realizes an equalizer function making phase compensation of the comparison result. The power reset unit 34 includes a transistor TR, a capacitor C1, an amplifier BF, resistors R7, r8, an AND circuit AD1 and an amplifier BF. The power reset unit 34 generates a reset signal with respect to the latch circuit 39 and the controller CNT in the output termination mode. The reset signal is made invalid by a watchdog timer function of the controller CNT, except the case of the out-of-control.

A part of light emitted from the laser diode LD is incident on the monitor diode MD to be output as a monitor signal. Current-to-voltage conversion of the monitor signal is made by the I-V converter 32 so that the monitor signal has a voltage proportional to a laser output. The voltage is converted to digital data by the A/D converter 36. The digital data is compared with the reference 2, and then, the error signal is corrected and amplified with respect to frequency characteristic by an equalizer (EQ) comprising a digital filter. The data thus obtained is converted to an analog signal by the D/A converter 37. The controller CNT executes software, and thereby, the foregoing digital signal processing is carried out. The analog signal is input to the low-pass filter 40 via the analog switch unit 35. An output signal of the low-pass filter 40 is input to the laser driver 31. The current corresponding to the signal input to the laser driver 31 flows through the laser diode LD, and a laser output is obtained from the laser diode in accordance with the reference 2.

On the other hand, the monitor signal from the I-V converter 32 is compared with the reference 1 using a comparator CP. Noise removal deglitch is carried out using the low-pass filter 38, and thereafter, the latch circuit holds the deglitch result. Static electricity and power noise are given as noise factors. In apparatuses using a commercial utility source, the time of noise coming from a power source is about 1 μsec to the maximum. Thus, the low-pass filter 38 is configured to carry out deglitch of removing 2 μsec noise. Therefore, if the monitor signal exceeds the reference 1 and continues for more than 2 μsec, the RS flip-flop of the latch circuit 39 is set. In this case, an output enable signal OEN becomes a level L to turn off the switch unit 35. As a result, the input level of the low-pass filter 40 becomes zero. The response time constant of the low-pass filter 40 is set to 200 μsec so that it becomes later than the deglitch response.

In the optical disk drive, two methods are given as ways of canceling the latch. One is the case where the out-of-control of the controller CNT occurs; as a result, the laser output becomes excessive. In this case, the watchdog timer monitoring the out-of-control of the controller CNT resets the latch circuit 39 via the power reset unit 34. Another is the case where the latch circuit 39 is set due to noise entering when the out-of-control of the controller CNT does not occur. In this case, the controller CNT recognizes a state of the latch circuit 39 by INP input, and resets the latch circuit 39 by OTP output. In this embodiment, the APC circuit 24 normally controls the laser output. Thus, the controller CNT resets the latch circuit 39 after temporarily setting the output of the D/A converter 37.

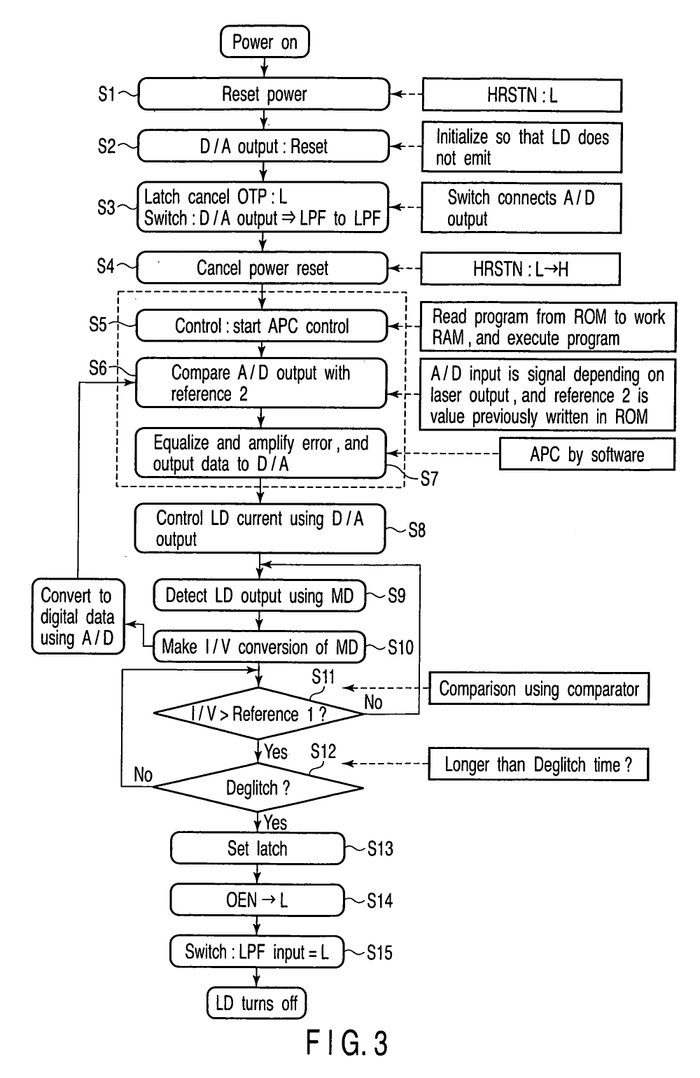

FIG. 3 shows the flow of laser power control. When the power is turned on, the power is reset by setting an HRSTN signal to L (level) in step S1. Then, the output of the D/A converter 37 is set to L, and thereby, the laser diode is initialized so that it is not emitted. In step S3, latch cancel is made by setting an OTP signal to L, and then, the switch unit 35 connects the output of the A/D converter 37 to the low-pass filter 40. In step S5, the controller CNT reads programs from the ROM to a work RAM to execute the programs, and thereby, starts APC control. In step S6, a comparison is made between the output of the A/D converter 36 and the reference 2. In this case, the input of the A/D converter 36 is a signal depending on the laser output, and the reference 2 is a reference value previously stored in the ROM. In step S7, an error signal is equalized and amplified, and thereafter, the result is output to the D/A converter 37. In step S8, the current of the laser diode LD is controlled by the output of the D/A converter 37. In step S9, a laser output is detected by the monitor diode MD. In step S10, current-to-voltage conversion of the monitor signal from the monitor diode MD is made. The current-to-voltage conversion result is converted to digital data by the A/d converter 36 to change the output of the A/D converter 36 used in step S6. On the other hand, in step S11, a check is made as to whether or not the current-to-voltage conversion result is larger than the reference 1. If the result is not larger than the reference 1, the procedure of step S9 is carried out. Conversely, if the result is larger than the reference 1, a check is made in step S12 as to whether or not deglitch is longer than a predetermined time. If the deglitch is not longer, the procedure of step S11 is carried out. Conversely, if deglitch is longer, in step S13, the latch circuit 39 is set in the output termination mode. In this way, in step S13, an OEN signal is set to L, and in step S15, the switch unit 35 sets the input of the low-pass filter 40 to L. The laser diode LD is turned off in the manner as described above.

In step 11, the reference 1 is basically configured by hardware in such a manner that the resistor is used in this embodiment. In this case, the reference 1 may be set using software. However, the following protection system is required. The protection system recognizes that the out-of-control of the software does not occur, and is set at that time. If rewrite is made using software, rewrite is made after recognizing that the out-of-control of the software does not occur.

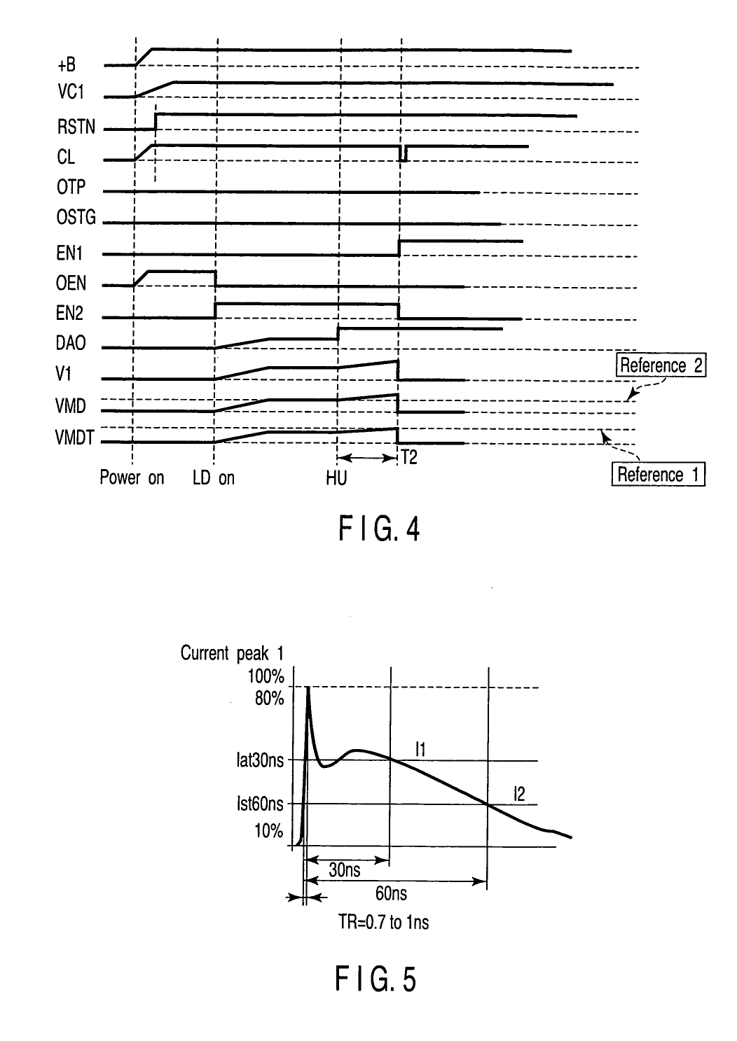

FIG. 4 shows signal waves obtained in laser power control.

In a reset state, when power +B is made, a both-terminal voltage VC1 of the capacitor C1 increases depending on the time constant with R8. When exceeding an input threshold voltage of a buffer BF, an output RSTN is inverted from L to H. When the output RSTN is L, a reset state is given. When receiving the output RSTN by HRSTN, the controller transfers to a hardware reset state, and sets DO to zero so that the D/A output is set to zero. When EN2 is set to H and OEN is set to L, SW is connected to G. In this way, a control signal VI input to the LDD 31 becomes zero; as a result, the laser diode current becomes zero. Thus, no optical input is given to the MD; for this reason, VMD is 0 V. VMDT is lower than the reference 1; for this reason, a CL signal becomes H (high). An AD1 signal is L (low); for this reason, an output of ND2 becomes H. Therefore, an ND1 output EN1 becomes L (low). In the reset state, OTP is set to H (high).

According to the controller reset cancel, when RSTN becomes H, HRSTN (hardware reset input) of the controller becomes H to load programs from the ROM to a working RAM so that a predetermined program is started. EN2 is set to L and OEN is set to H, and further, SW is connected to CTS. DAO is L (low); for this reason, the laser diode LD is not activated.

According to a laser diode LD on/APC operation, the controller sets EN2 to L, and sets OEN to H, and further, connects SW to CTS. A VMD signal corresponding to the output of the laser diode LD is always converted to digital data by the A/D converter, and then, given as DI to the controller. The reference 2 is a fixed value stored in the ROM. The controller makes the following software operation. Specifically, the controller compares the DI with the reference 2, and then, equalizes (EQ) the error signal, and further, outputs the amplified data as DO. In this case, EQ is LPF (primary low-pass filter) in general. The foregoing operation forms a negative feedback control loop so that the VMD corresponding to the output of the laser diode LD and the value of the reference 2 become equal.

Incidentally, each low-pass filter controls the response time of the control loop. Specifically, the response time is set to a relation of LPF>LPF 40>LPF 38 as standard. DAO and VI successively increase according to the response of APC loop from the laser diode on in the timing chart to increase the laser diode LD current. When the laser diode LD is activated, the light is incident on the monitor diode MD; therefore, VMD and VMDT increase, and is stable when the reference 2 and VMD are equal.

Regarding the protection operation of the laser diode LD, it is assumed that the out-of-control of the software occurs at the HU time in the timing chart, and all the bits of DAO output are H. In the period T2, VMDT increases. The time constant is controlled by the LPF 40. When the VMDT exceeds the reference 1 (time T2), CL becomes L, and ND1 output EN1 becomes H, and further, OEN becomes L. According to the foregoing operation, SW is connected to G, and an increase of VI stops, and then, gradually decreases toward zero. The operation is set so that the output of the laser diode LD does not destroy the software at the reference 1, and thereby, it is possible to prevent the laser diode LD from being destroyed.

Noise malfunction prevention will be described below. A protection operation of the laser diode is carried out due to noise such as electrostatic discharge (ESD) and lightning. Thus, malfunction prevention is required to keep the commercial value. It is estimated that ESD noise lasts for about 60 ns. Therefore, detection is made so that the response is made with respect to about 1 μs. In this case, the low-pass filter 38 is used.

Return from the protection operation of the laser diode LD will be described below. If the protection operation of the laser diode LD is carried out due to noise, the controller executes the following operations. Specifically, the controller monitors EN1, and sets EN2 to H (high), and further, instantaneously sets OTP to L (low), and in addition, sets ND1 output EN1 to L (low). If the out-of-control of the controller CNT occurs, the watchdog timer operates to set the OST to H (high) by a predetermined time, and thereby, turn on the TR. In this way, the controller makes a discharge of the CL, and sets RSTN to L (low), and thereby, the same operation as the foregoing reset is carried out to return the laser diode LD from the protection operation.

According to this embodiment, the output termination mode is set when the detector makes detection that a state that the monitor signal obtained from monitoring the laser output of the laser diode LD exceeds the reference 1 continues over a predetermined period. According to the set output termination mode, the laser output of the laser diode LD is terminated. For example, electrostatic noise enters, and thereby, even if the monitor signal temporarily increases to exceed the reference 1, this is cancelled within the foregoing predetermined period. In this case, the output termination mode is not set. In other words, the laser output of the laser diode LD is prevented from being unnecessarily terminated. If the out-of-control of the software controller occurs, an increase of the monitor signal is not cancelled within the foregoing predetermined period. Therefore, it is possible to securely protect the laser beam source from being destroyed.

The present invention is not limited to the foregoing embodiment, and various modifications may be made without departing from the scope of the invention.

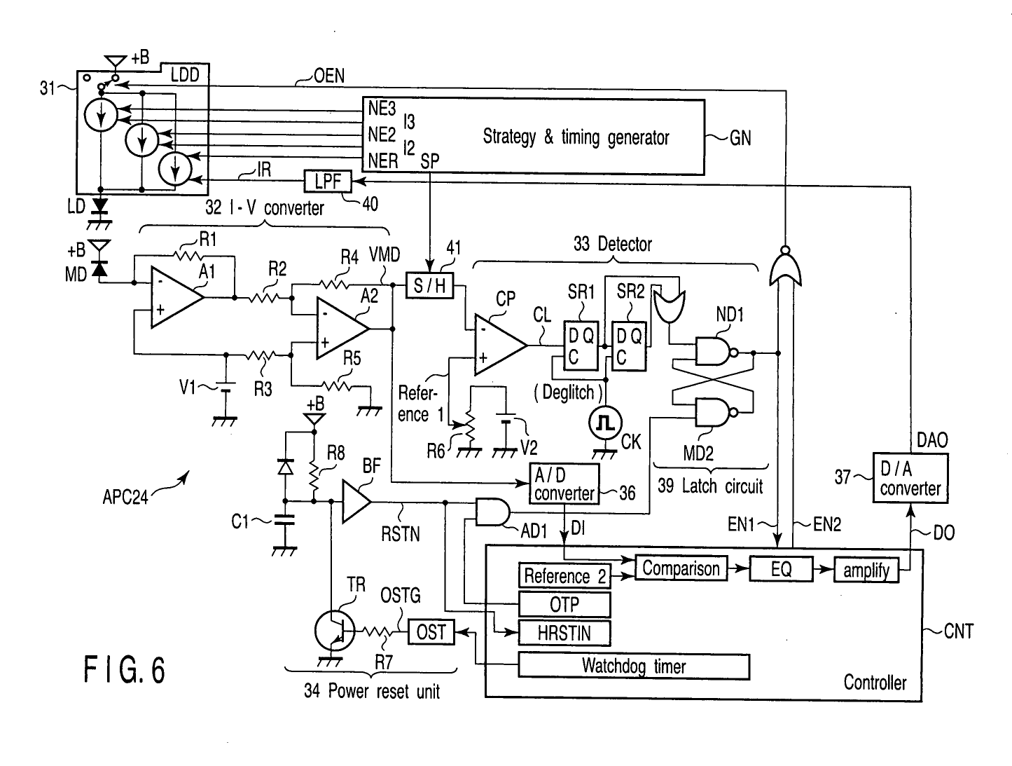

FIG. 6 shows an example of laser power control applied to a recording operation. For example, when recording is made with respect to a dye media, read power APC is carried out with respect to IR of a laser driver LDD as shown in FIG. 6. A recording current and timing are controlled in the following manner. Specifically, the current is controlled using GN, and the timing is controlled using OEN. 2 to 3 channels are used as a recording channel of the LDD. A sample hold circuit 41 selects and uses a read output operation value as an output of an I-V converter 32. In this case, deglitch is carried out by flip-flop SR1 and SR2. Incidentally, an OTP output is gated using EN1, and thereby, latch cancel is carried out only when protection latch is operating.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk drive comprising:
a monitor which monitors a laser output of a laser beam source irradiating a laser beam to an optical disk;
a detector which sets an output termination mode when a state that a monitor signal obtained from the monitor exceeds a first reference value continues over a predetermined period is detected from a deglitch;
an output termination circuit which terminates the laser output of the laser beam source upon setting of the output termination mode; and
a controller which supplies a drive signal for reducing a difference obtained as a comparison result between the monitor signal and a second reference value smaller than the first reference value to the laser beam source; the controller serving as a software-based digital filter which realizes an equalizer function of making phase compensation of the comparison result.

2. The drive according to claim 1, wherein the output termination circuit includes a delay unit which delays a drive signal supplied to the laser beam source for time longer than a predetermined period given as the standard of the deglitch.

3. The drive according to claim 1, wherein the detector includes: a latch circuit latching a deglitch result to set the output termination mode; and a power reset circuit generating a reset signal to the latch circuit and the controller in the output termination mode, and the reset signal is made invalid by a watchdog timer provided in the controller, except when the out-of-control of the controller occurs.

4. The drive according to claim 1, wherein the detector includes a low-pass filter with respect to the drive signal.

5. The drive according to claim 2, wherein the delay unit includes a low-pass filter with respect to the monitor signal.

6. A laser power control method comprises:
setting an output termination mode when a state that a monitor signal obtained by monitoring a laser output of a laser beam source irradiating a laser beam to an optical disk exceeds a first reference value continues over a predetermined period is detected;
terminating the laser output of the laser beam source upon setting of the output termination mode; supplying a drive signal for reducing a difference obtained as a comparison result between the monitor signal and a second reference value smaller than the first reference value to the laser beam source; and
realizing an equalizer function of making phase compensation of the comparison result by a controller which serves as a software-based digital filter.

7. The method according to claim 6, wherein a drive signal supplied to the laser beam source is delayed for time longer than a predetermined period given as the standard of the deglitch.

8. The method according to claim 6, wherein a deglitch result is latched by a latch circuit to set the output termination mode, and a reset signal to the latch circuit and the controller is generated by a power reset circuit in the output termination mode, and the reset signal is made invalid by a watchdog timer provided in the controller, except when the out-of-control of the controller occurs.

9. The method according to claim 6, wherein a low-pass filter is provided for delay with respect to the drive signal.

10. The method according to claim 7, wherein a low-pass filter is provided for deglitch with respect to the monitor signal.
